(19) United States
(12) Patent Application Publication
(10) Pub. No.: US 2011/0296460 A1
(43) Pub. Date: Dec. 1, 2011

(54) METHOD AND APPARATUS FOR PROVIDING REMOTE USER INTERFACE (UI) SERVICE

(75) Inventors: Ho Jin, Yongin-si (KR); Kwang-kee Lee, Seoul (KR); Young-chul Sohn, Seoul (KR); Soo-min Shin, Suwon-si (KR)

(73) Assignee: SAMSUNG ELECTRONICS CO., LTD., Suwon-si (KR)

(21) Appl. No.: 13/118,916

(22) Filed: May 31, 2011

Related U.S. Application Data
(60) Provisional application No. 61/350,010, filed on May 31, 2010.

(30) Foreign Application Priority Data
Sep. 16, 2010 (KR) 10-2010-0091099

(51) Int. Cl. H04N 5/445

(52) U.S. Cl. 725/37

(57) ABSTRACT

A method and apparatus for providing a remote User Interface (UI) service in a remote UI server, including: receiving description information of a remote UI client and an Audio Video (AV) device from a remote UI proxy server; generating a first UI resource based on the received description information; and transmitting the first UI resource to the remote UI client in response to a request of the remote UI client.

### CROSS-REFERENCE TO RELATED PATENT APPLICATION

This application claims priority from U.S. Provisional Application No. 61/350,010, filed on May 31, 2010, in the United States Patent and Trademark Office, and Korean Patent Application No. 10-2010-0091099, filed on Sep. 16, 2010, in the Korean Intellectual Property Office, the disclosures of which are incorporated herein by reference in their entireties.

### BACKGROUND

1. Field

Apparatus and methods consistent with exemplary embodiments relate to providing a remote User Interface (UI) service, and more particularly, to a remote UI service providing method and apparatus for controlling content by using remote UI technology between home network devices, including a remote UI server (e.g., a headend device), a remote UI proxy server (e.g., a relay gateway (proxy gateway) device), a remote UI client, and an Audio Video (AV) device.

2. Description of the Related Art

A subscriber uses a set-top box capable of reproducing provider broadcasting and a television (TV) to enjoy the provider broadcasting. Also, in order to enjoy provider broadcasting with a plurality of TVs in a home network, a user accesses the provider broadcasting by using a set-top box reproducing the provider broadcasting, which corresponds to each TV.

In order to enjoy provider broadcasting with a plurality of TVs in a home network, a user may access services of a plurality of providers with one set-top box. In this case, the set-top box must manage and support a broadcast service for each provider and provide information to home network devices (ex. a TV, a Mobile AV device, a cellular phone, etc.) so that the home network devices can access the provider services.

Typically, each set-top box and home network device can be controlled through a User Interface (UI) provided by its manufacturer for a corresponding device.

Due to the specific device independent control for set-top boxes and home network devices, in order to expand a device control right to a home network, a new function must be implemented according to a standard defined between the devices.

For example, in order for a user to perform a control operation, such as reproduction of a desired broadcasting program in a TV after checking Electronic Program Guide (EPG) information of a broadcasting signal received by a set-top box by using a cellular phone in a home network, a new standard is necessary among the cellular phone, the set-top box, and the TV. Although the user can check the EPG information of the set-top box by using the cellular phone, there is a burden that both the cellular phone and the set-top box must add a new function.

### SUMMARY

Exemplary embodiments provide a remote User Interface (UI) service providing method and apparatus for controlling content by using remote UI technology between home network devices, including a remote UI server (e.g., a headend device), a remote UI proxy server (e.g., a relay gateway (proxy gateway) device), a remote UI client, and an Audio Video (AV) device.

Exemplary embodiments also provide a computer readable recording medium storing a computer readable program for executing the method.

According to an aspect of an exemplary embodiment, there is provided a method of providing a remote UI service in a remote UI server, including: receiving description information of a remote UI client and an AV device from a remote UI proxy server; generating a first UI resource based on the received description information; and transmitting the first UI resource to the remote UI client in response to a request of the remote UI client.

The first UI resource may include a device control UI for controlling the remote UI client and the AV device and a content UI for controlling broadcast content; and the first UI resource may be realized using at least one of a web page, a bitmap of applications, and a graphic primitive of applications and provide a UI for receiving a control command for controlling the devices and the broadcast content.

The method may further include: receiving a broadcast content control command for controlling the broadcast content from the remote UI client; controlling the broadcast content based on the broadcast content control command; generating a second UI resource for providing a UI related to outputting a control result of the broadcast content, based on the control result of the broadcast content; and transmitting the second UI resource to the remote UI client.

The remote UI server may be a headend device.

According to another aspect of an exemplary embodiment, there is provided a method of providing a remote UI service in a remote UI proxy server, including: receiving first description information of at least one of a remote UI client and an AV device from said at least one of the remote UI client and the AV device; transmitting the first description information of the at least one of the remote UI client and the AV device to a remote UI server; receiving second description information of the remote UI server from the remote UI server; and transmitting the second description information of the remote UI server to the remote UI client.

The method may further include receiving broadcast content from the remote UI server. The receiving of the broadcast content from the remote UI server may be based on a request of the remote UI client.

The method may further include: transforming the broadcast content to an Internet Protocol (IP) packet; and transmitting the transformed broadcast content to the AV device. The transformed broadcast content may be transmitted to the AV device based on a request of the remote UI client.

The remote UI proxy server may be one of a relay gateway (proxy gateway), a set-top box, and a Personal Video Recorder (PVR).

According to another aspect of the present invention, there is provided a method of providing a remote UI service in a remote UI client, including: receiving description information of a remote UI server from a remote UI proxy server; requesting a first UI resource from the remote UI server based on the description information; and receiving the first UI resource from the remote UI server.

The first UI resource may include a device control UI for controlling at least one of the remote UI client and the AV device, and a content UI for controlling broadcast content; and the first UI resource may be realized using at least one of a web page, a bitmap of applications, and a graphic primitive of applications and may provide a UI for receiving a control command for controlling the devices and the broadcast content.

The method may further include: transmitting a command for controlling the broadcast content to the remote UI server; and receiving a second UI resource for providing a UI related to outputting a control result of the broadcast content from to the remote UI server.

The method may further include transmitting a command for controlling the AV device by using the device control UI, to the AV device.

The transmitting of the command for controlling the AV device by using the device control UI to the AV device may include transmitting a reproduction command to the AV device by using one of a HyperText Transfer Protocol (HTTP) Request according to the Digital Living Network Alliance (DLNA)/Consumer Electronics Association (CEA) 2014 standard, an additional HTTP Request according to Asynchronous JavaScript and XML (Ajax), and a plug-in application performing a control point function.

The method may further include transmitting to the remote UI proxy server an HTTP Request for controlling a control point in the remote UI proxy server to transmit a command for controlling the AV device to the AV device.

The remote UI client may be a user device in a home network.

According to another aspect of an exemplary embodiment, there is provided a computer readable recording medium configured to perform a set of operations based on a corresponding set of instructions contained in the computer readable medium, the set of operations comprising the operations of a method.

According another aspect of an exemplary embodiment, there is provided a remote UI server including: an information receiver which receives description information of at least one of a remote UI client and an AV device from a remote UI proxy server; a first UI generator for generating a first UI resource based on the received description information; and a first UI transmitter which transmits the first UI resource to the remote UI client in response to a request of the remote UI client.

According to another aspect of an exemplary embodiment, there is provided a remote UI proxy server including: a first information receiver which receives first description information of at least one of a remote UI client and an AV device from the at least one of the remote UI client and the AV device; a first information transmitter which transmits the first description information of the at least one of the remote UI client and the AV device, to a remote UI server; a second information receiver which receives second description information of the remote UI server from the remote UI server; and a second information transmitter which transmits the second description information of the remote UI server to the remote UI client.

According to another aspect of an exemplary embodiment, there is provided a remote UI client including: an information receiver which receives description information of a remote UI server from a remote UI proxy server; a UI requester which requests a first UI resource from the remote UI server based on the description information; and a first UI receiver which receives the first UI resource from the remote UI server.

### BRIEF DESCRIPTION OF THE DRAWINGS

The above and other aspects will become more apparent by describing in detail exemplary embodiments thereof with reference to the attached drawings in which:

FIG. 1 is a schematic diagram of a system architecture for providing a remote UI service;

FIG. 2 is a signaling diagram of a discovery and broadcast content control process in a remote UI service providing method according to an exemplary embodiment;

FIG. 3 is a signaling diagram of a process of performing control between home network devices in the remote UI service providing method according to an exemplary embodiment;

FIG. 4 is a syntax of a process of performing control between home network devices using an Ajax HTTP Request according to an exemplary embodiment;

FIG. 5 is a syntax of a process of performing control between home network devices using a Control Point (CP) plug-in application in a remote UI client according to another exemplary embodiment;

FIG. 6 is a block diagram of a remote UI server according to an exemplary embodiment;

FIG. 7 is a block diagram of a remote UI proxy server according to an exemplary embodiment; and

FIG. 8 is a block diagram of a remote UI client according to an exemplary embodiment.

### DETAILED DESCRIPTION OF EXEMPLARY EMBODIMENTS

Aspects of the Exemplary embodiments will now be described more fully with reference to the accompanying drawings. Like reference numerals denote like elements, and the sizes of components in the drawings may be exaggerated for clarity of description.

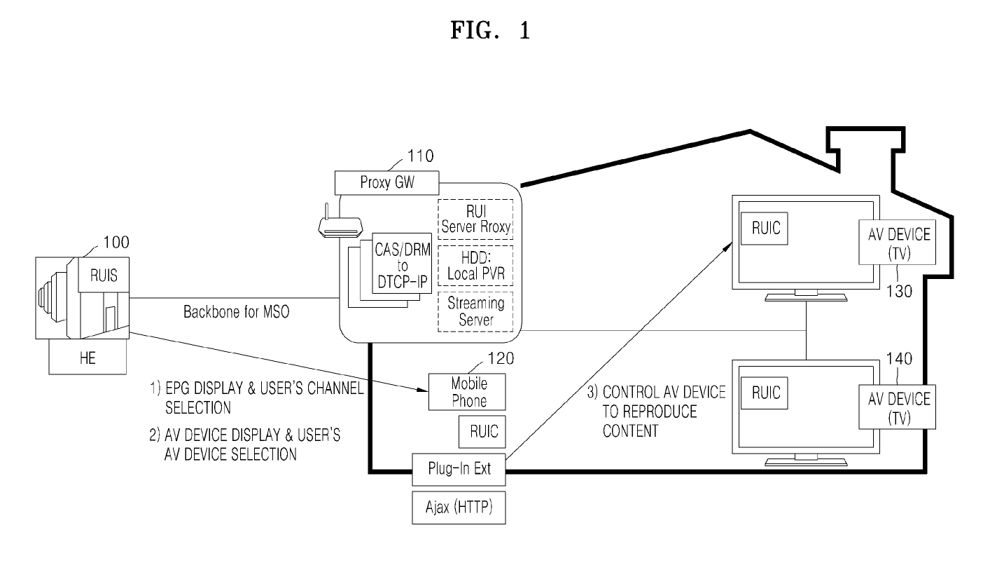

FIG. 1 is a schematic diagram of a system architecture for providing a remote UI service.

Referring to FIG. 1, a system for providing a remote UI service includes home network devices, including a remote User Interface (UI) server 100, a remote UI proxy server 110, a remote UI client 120, and Audio Video (AV) devices 130 and 140. The remote UI server 100 includes a headend device, and the remote UI proxy server 110 includes a relay gateway (proxy gateway) device.

The headend device is also called a cable headend and is a facility at a regional cable TV office to provide a cable TV service and a cable modem service to cable subscribers. The headend device provides broadcast content, including real-time broadcasting and Video on Demand (VoD), to subscribers.

The remote UI server 100 provides broadcast content to the AV devices 130 and 140 through the remote UI proxy server 110 in a home network to which a subscriber belongs. The remote UI server 100 also provides a UI resource for controlling a provider service and a UI resource for controlling the home network devices to the remote UI client 120 in the home network to which the subscriber belongs. The provider service includes services such as providing broadcast content, including real-time broadcasting and VoD, and providing provider service access information.

The UI resources are realized using at least one of a web page, a bitmap of applications, and a graphic primitive of applications. The UI resources provide a UI for receiving a control command for controlling the provider service and the home network devices from the outside.

For example, each of the UI resources can be a UI resource corresponding to an Electronic Program Guide (EPG). The EPG is an application for displaying a broadcast program guide on a display screen, and a subscriber can select a desired program through the EPG or search for a desired program using a criterion, such as time, title, channel, and genre, by using the remote UI client 120.

In home networks constructed using Digital Living Network Alliance (DLNA)/Universal Plug and Play (UPnP) technology, since home network devices discover each other by using multicast communication, the device discovery has a restriction in that the device discovery can be performed within only a home network domain.

Thus, the remote UI server 100 according to an exemplary embodiment of the present invention receives description information of the home network devices from the remote UI proxy server 110 in order to provide the UI resource for controlling the home network devices to the remote UI client 120. The remote UI server 100 can form a UI for controlling the home network devices based on the received description information.

Thereafter, the remote UI server 100 receives a control command for controlling the provider service, from the remote UI client 120. The remote UI server 100 controls the provider service based on the provider service control command. The remote UI server 100 generates a UI resource for providing a UI for outputting a provider service control result, based on the provider service control result. The remote UI server 100 provides the generated UI resource to the remote UI client 120.

The remote UI proxy server 110 receives the description information of the home network devices from the home network devices and transmits the description information to the remote UI server 100 so that the remote UI server 100 can generate the UI resource for controlling the home network devices. The remote UI proxy server 110 also receives description information of the remote UI server 100 and transmits the received description information to the remote UI client 120 so that the remote UI client 120 can request a UI resource from the remote UI server 100.

The remote UI proxy server 110 receives a provider service including broadcast content from the remote UI server 100 based on a control command from the remote UI client 120.

The remote UI proxy server 110 transforms the broadcast content to an Internet Protocol (IP) packet and transmits the transformed broadcast content to the AV devices 130 and 140 in the home network based on a control command from the remote UI client 120.

The remote UI client 120 receives the description information of the remote UI server 100 from the remote UI proxy server 110. The remote UI client 120 requests a UI resource from the remote UI server 100 based on the received description information and receives the UI resource from the remote UI server 100.

The remote UI client 120 transmits a control command for controlling the provider service to the remote UI server 100 by using the UI resource. Thereafter, the remote UI client 120 receives the UI resource for providing a UI for outputting a provider service control result, from the remote UI server 100.

The remote UI client 120 also can directly transmit a command for controlling the AV devices 130 and 140 to the AV devices 130 and 140 by using the UI resource for controlling the home network devices (ex. an AV device), which has been received from the remote UI server 100.

For example, the remote UI client 120 can directly transmit a command for reproducing broadcast content in the AV devices 130 and 140 to the AV devices 130 and 140 by using the UI resource.

The remote UI client 120 can transmit a command for controlling the AV devices 130 and 140 to the AV devices 130 and 140 by using one of a HyperText Transfer Protocol (HTTP) Request according to the Digital Living Network Alliance (DLNA)/Consumer Electronics Association (CEA) 2014 standard, an additional HTTP Request according to Asynchronous JavaScript and XML (Ajax), and a plug-in application performing a control point function.

The remote UI client 120 also may transmit to the remote UI proxy server 110 an HTTP Request for controlling a control point in the remote UI proxy server 110 to transmit a command for controlling the AV devices 130 and 140 to the AV devices 130 and 140.

Although the remote UI client 120 and the AV devices 130 and 140 are separately described in an exemplary embodiment, it is well known by those of ordinary skill in the art that the remote UI client 120 and the AV devices 130 and 140 can operate in one physical device.

According to an exemplary embodiment, content can be easily controlled by using remote UI technology between home network devices, including a remote UI server (ex. a headend device), a remote UI proxy server (ex. a relay gateway (proxy gateway) device), a remote UI client, and an AV device. According to the current embodiment, a provider service is shared by using a UI resource preferred by service providers instead of being shared by using metadata, so that a subscriber can control the provider service.

According to an exemplary embodiment, the home network devices and the remote UI server 100 can be easily controlled even while the remote UI client 120 is moving.

In addition, the remote UI client 120 can be a physically separate device from the remote UI proxy server 110 and the AV devices 130 and 140 by using the remote UI technology. Accordingly, since a screen for reproducing content and a screen for controlling the content can be displayed on separate devices, a relatively pleasant view environment can be provided to a subscriber. The remote UI client 120 can directly receive a UI resource from the remote UI server 100 and then link various controls with the home network devices. Thus, the provider service can be expanded in the home network by upgrading remote UI-related software in the remote UI server 100.

Since the AV devices 130 and 140 also can be physically separate devices from the remote UI proxy server 110, even though a separate tuner does not exist in the AV devices 130 and 140, a subscriber can enjoy a real-time broadcasting program through the remote UI proxy server 110.

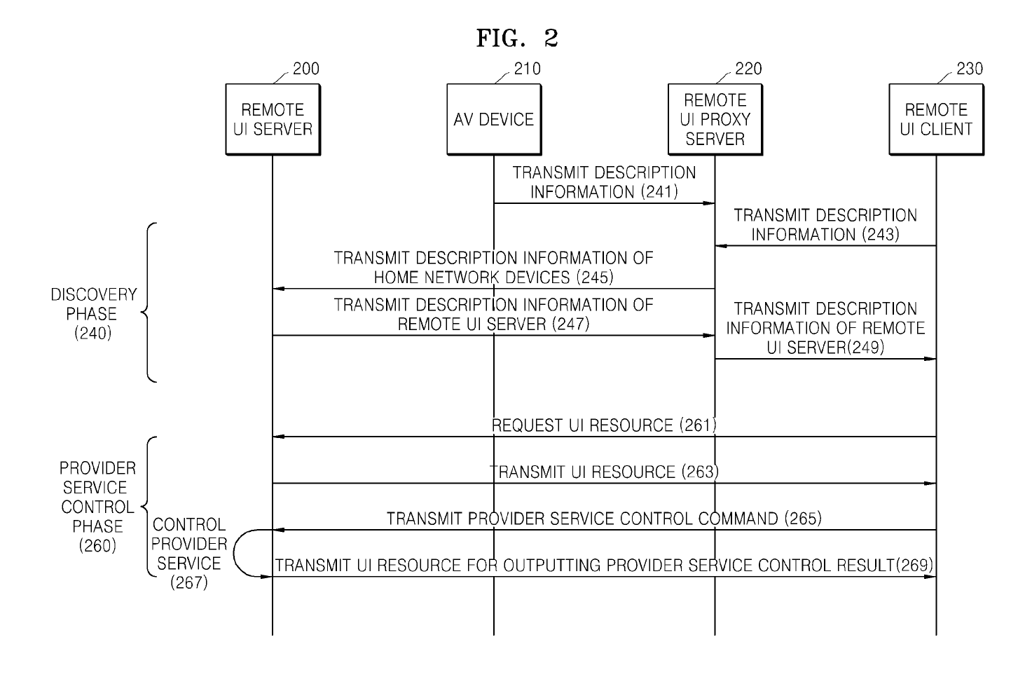

FIG. 2 is a signaling diagram of a discovery and broadcast content control process in a remote UI service providing method according to an exemplary embodiment.

In a home network constructed by using DLNA/UPnP technology, since home network devices discover another device by using multicast communication, the device discovery has a restriction in that the device discovery can be performed within only a home network domain.

Thus, in discovery operation 240 in the remote UI service providing method, a remote UI server 200, a remote UI client 230, and an AV device 210 share their own description information through a remote UI proxy server 220.

In operations 241 and 243, the AV device 210 and the remote UI client 230 transmit their own description information to the remote UI proxy server 220.

In operation 245, the remote UI proxy server 220 transmits the received description information to the remote UI server 200.

In operation 247, the remote UI server 200 transmits its own description information to the remote UI proxy server 220.

In operation 249, the remote UI proxy server 220 transmits the received description information to the remote UI client 230.

In broadcast content control operation 260 in the remote UI service providing method, the remote UI server 200 provides a UI resource for controlling a provider service and a UI resource for controlling home network devices to the remote UI client 230 in a home network to which a subscriber belongs so that the remote UI client 230 can control the provider service and the home network devices through the UI resources thereafter.

In operation 261, the remote UI client 230 requests the UI resources to the remote UI server 200 based on the description information.

The UI resources are realized using at least one of a web page, a bitmap of applications, and a graphic primitive of applications. The UI resources provide a UI for receiving a control command for controlling the provider service and the home network devices from the outside.

For example, each of the UI resources can be a UI resource corresponding to EPG. The EPG is an application for displaying a broadcast program guide on a display screen, and a subscriber can select a desired program through the EPG or search for a desired program using a criterion, such as time, title, channel, and genre, by using the remote UI client 230.

In operation 263, the remote UI client 230 receives the UI resources from the remote UI server 200.

In operation 265, the remote UI client 230 transmits a control command for controlling the provider service to the remote UI server 200 by using the UI resources. In the shown example, the control command for controlling the provider service can be a command for controlling broadcast content.

In operation 267, the remote UI server 200 controls the provider service based on the provider service control command. The remote UI server 200 may control a specific function of the remote UI proxy server 220 according to the control command. For example, the remote UI server 200 can transmit a control command for changing a channel to the remote UI proxy server 220 based on the control command of the remote UI client 230.

The remote UI server 200 generates a UI resource for providing a UI for outputting a provider service control result, based on the provider service control result.

In operation 269, the remote UI client 230 receives the UI resource for providing a UI for outputting a provider service control result from the remote UI server 200.

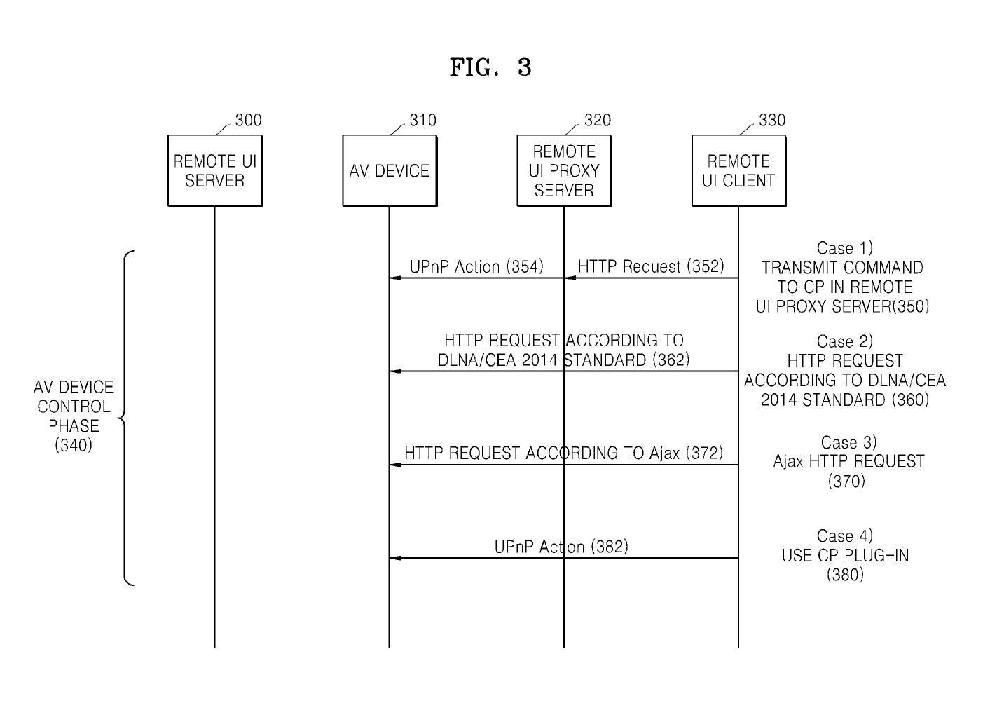

FIG. 3 is a signaling diagram of a process of performing control between home network devices in the remote UI service providing method according to an exemplary embodiment of the present invention.

In operation 340, which relates to performing control between home network devices in the remote UI service providing method, a remote UI server 300 provides a UI resource for controlling home network devices to a remote UI client 330 in a home network to which a subscriber belongs, so that the remote UI client 330 can control the home network devices through the UI resource thereafter.

The remote UI client 330 can transmit a command for controlling an AV device 310, to the AV device 310 by using one of an HTTP Request 360 according to the DLNA/CEA 2014 standard, an additional HTTP Request 370 according to Ajax, and a plug-in application 380 performing a control point function.

When using the HTTP Request 360 according to the DLNA/CEA 2014 standard, in operation 362, the remote UI client 330 transmits a DLNA/CEA 2014 Remote User Interface (RUI) HTTP Request in the form of “Http://clientURI&serverURI” to the AV device 310.

For example, when a Uniform Resource Identifier (URI) of the AV device 310 is “192.168.1.5” and a URI of the remote UI server 300 is “10.168.1.10”, the remote UI client 330 transmits an HTTP Request in the form of “Http://192.168.1.5&10.168.1.10/index_LiveCh5.html” to the AV device 310.

In the case of using the additional HTTP Request 370 according to Ajax, in operation 372, the remote UI client 330 can transmit the additional HTTP Request 370 using Ajax to the AV device 310 when the remote UI client 330 is connected to the remote UI server 300 or a remote UI proxy server 320.

In the case of using the plug-in application 380 performing a control point function, in operation 382, the remote UI client 330 can transmit a UPnP Action to the AV device 310. The control point (CP) includes a UPnP AV CP and a UPnP RUI CP.

The plug-in application 380 performing a CP function in the remote UI client 330 can search for the AV device 310 in the home network and transmit the UPnP Action to the AV device 310.

In addition, the remote UI client 330 may transmit to the remote UI proxy server 320 an HTTP Request for controlling a CP in the remote UI proxy server 320 to transmit a command for controlling the AV device 310, to the AV device 310 (350).

In operation 352, the remote UI client 330 transmits to the CP in the remote UI proxy server 320 an HTTP Request for requesting the CP in the remote UI proxy server 320 to transmit a control command to the AV device 310. The remote UI client 330 can acquire a URI corresponding to the CP in the remote UI proxy server 320 through a UI resource provided in advance by the remote UI server 300.

In operation 354, the CP in the remote UI proxy server 320 transmits a UPnP Action to the AV device 310 based on the received HTTP Request control command.

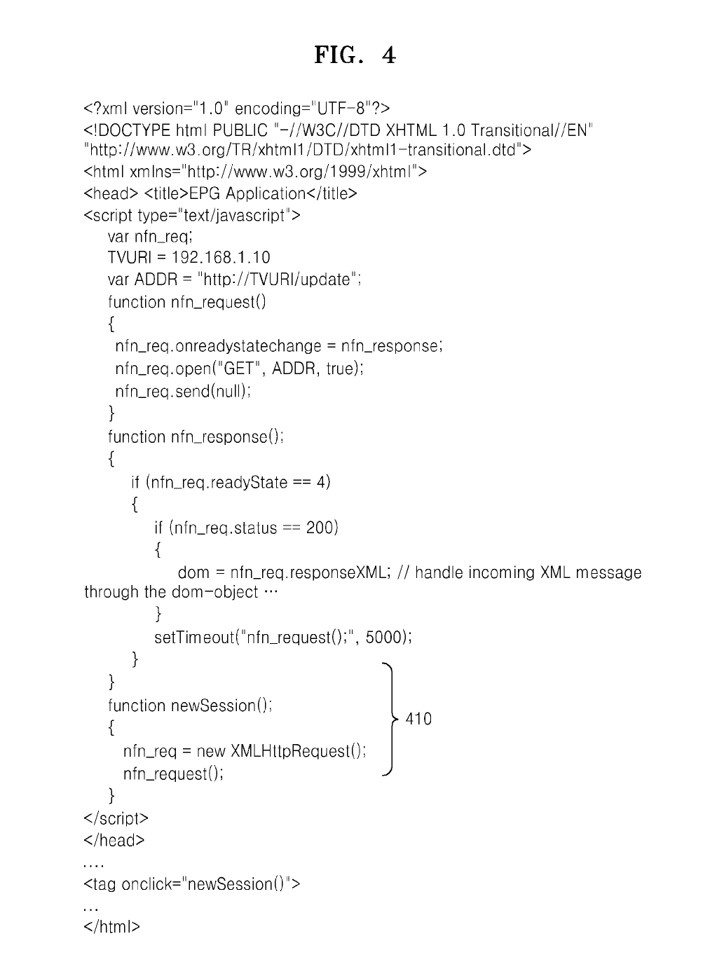

FIG. 4 is a syntax of a process of performing control between home network devices using an Ajax HTTP Request according to an exemplary embodiment.

When using the additional HTTP Request 370 according to Ajax, the remote UI client 330 can transmit an additional HTTP Request using Ajax to the AV device 310 while the remote UI client 330 is connected to the remote UI server 300 or the remote UI proxy server 320.

Ajax indicates a web development scheme for producing an interactive web application, in which data can be exchanged and operated with a web server in an asynchronous method. Detailed description of Ajax is omitted herein.

In the shown example, it is shown that an additional HTTP Request using Ajax is generated in a JavaScript (410).

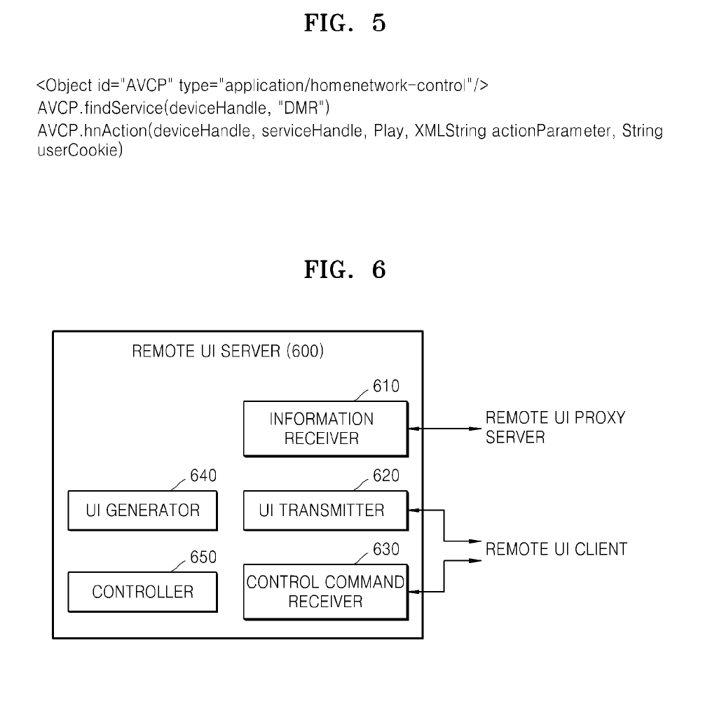

FIG. 5 is a syntax of a process of performing control between home network devices using a CP plug-in application in a remote UI client according to another exemplary embodiment.

In the case of using the plug-in application 380 performing a CP function, the remote UI client 330 can transmit a UPnP Action to the AV device 310. The CP includes a UPnP AV CP and a UPnP RUI CP.

In the shown example, a case where the plug-in application 380 is a UPnP AV CP is shown. The UPnP AV CP plug-in application can discover an AV device corresponding to a UPnP Digital Media Renderer (DMR) and transmits a UPnP Action to the AV device.

FIG. 6 is a block diagram of a remote UI server 600 according to an exemplary embodiment.

The remote UI server 600 includes an information receiver 610, a UI generator 640, a UI transmitter 620, a control command receiver 630, and a controller 650.

The information receiver 610 receives description information of a remote UI client 800 and an AV device (not shown) from a remote UI proxy server 700.

The UI generator 640 can include a first UI generator (not shown) and a second UI generator (not shown). The first UI generator generates a first UI resource based on the received description information.

The first UI resource includes a device control UI for controlling the remote UI client 800 and the AV device and a content UI for controlling broadcast content. The first UI resource is realized using at least one of a web page, a bitmap of applications, and a graphic primitive of applications, and provides a UI for receiving a control command for controlling the devices and the broadcast content from the outside.

The second UI generator generates a second UI resource for providing a UI for outputting a broadcast content control result of the controller 650 to be described later, based on the broadcast content control result.

The UI transmitter 620 can include a first UI transmitter (not shown) and a second UI transmitter (not shown). The first UI transmitter transmits the first UI resource to the remote UI client 800 in response to a request of the remote UI client 800.

The second UI transmitter transmits the second UI resource to the remote UI client 800.

The control command receiver 630 receives a command for controlling broadcast content from the remote UI client 800.

The controller 650 controls the broadcast content based on the broadcast content control command received by the control command receiver 630.

Also, the remote UI server 600 can further include a content transmitter (not shown). The content transmitter transmits the broadcast content to the remote UI proxy server 700 based on a control command of the remote UI client 800.

The remote UI server 600 can be a headend device.

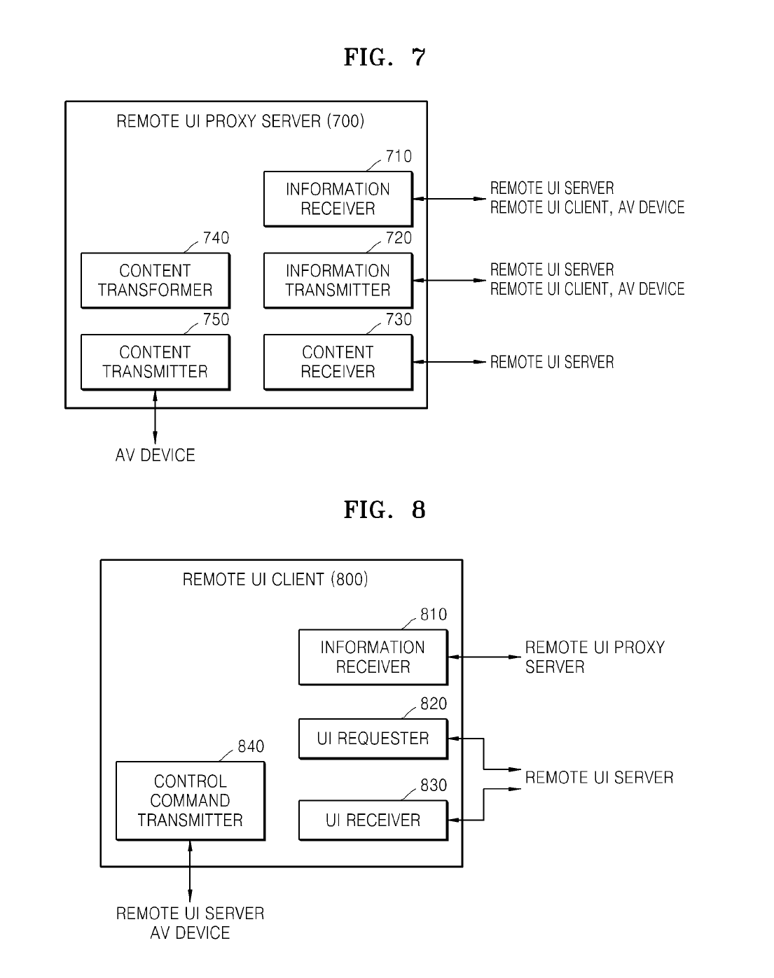

FIG. 7 is a block diagram of the remote UI proxy server 700 according to an exemplary embodiment.

The remote UI proxy server 700 includes an information receiver 710, an information transmitter 720, a content receiver 730, a content transformer 740, and a content transmitter 750.

The information receiver 710 can include a first information receiver (not shown) and a second information receiver (not shown).

The first information receiver receives description information of the remote UI client 800 and the AV device from the remote UI client 800 and the AV device. The second information receiver receives description information of the remote UI server 600 from the remote UI server 600.

The information transmitter 720 can include a first information transmitter (not shown) and a second information transmitter (not shown). The first information transmitter transmits the description information of the remote UI client 800 and the AV device to the remote UI server 600. The second information transmitter transmits the description information of the remote UI server 600 to the remote UI client 800.

The content receiver 730 receives broadcast content from the remote UI server 600 based on a request of the remote UI client 800. In more detail, the content receiver 730 receives broadcast content from the remote UI server 600 by controlling its own tuner according to a control command of the remote UI server 600 based on a request of the remote UI client 800.

The content transformer 740 transforms the broadcast content received from the remote UI server 600 to an IP packet.

The content transmitter 750 transmits the transformed broadcast content to the AV device based on a request of the remote UI client 800.

The remote UI proxy server 700 can be realized using a UPnP AV CP or a UPnP RUI CP. The remote UI proxy server 700 can be one of a relay gateway (proxy gateway), a set-top box, and a PVR.

FIG. 8 is a block diagram of the remote UI client 800 according to an exemplary embodiment.

The remote UI client 800 includes an information receiver 810, a UI requester 820, a UI receiver 830, and a control command transmitter 840.

The information receiver 810 receives the description information of the remote UI server 600 from the remote UI proxy server 700.

The UI requester 820 requests the first UI resource from the remote UI server 600 based on the received description information. The UI requester 820 can request a UI resource optimized to the remote UI client 800 from the remote UI server 600 through a pre-negotiation process of a capability manager (not shown).

The first UI resource includes the device control UI for controlling the remote UI client 800 and the AV device and the content UI for controlling broadcast content. The first UI resource is realized using at least one of a web page, a bitmap of applications, and a graphic primitive of applications, and provides a UI for receiving a control command for controlling the devices and the broadcast content from the outside. The UI receiver 830 can include a first UI receiver (not shown) and a second UI receiver (not shown).

The first UI receiver receives the first UI resource from the remote UI server 600.

The second UI receiver receives the second UI resource for providing a UI for outputting a broadcast content control result from the remote UI server 600.

The control command transmitter 840 can include a first control command transmitter (not shown), a second control command transmitter (not shown), and a third control command transmitter (not shown).

The first control command transmitter transmits a command for controlling broadcast content to the remote UI server 600 by using the content UI for controlling broadcast content, which has been received by the first UI receiver.

The second control command transmitter transmits a command for controlling the AV device to the AV device by using the device control UI, which has been received by the first UI receiver. The second control command transmitter transmits a command for controlling the AV device to the AV device by using one of an HTTP Request according to the DLNA/CEA 2014 standard, an additional HTTP Request according to Ajax, and a plug-in application performing a CP function.

The third control command transmitter transmits to the remote UI proxy server 700 an HTTP Request for controlling a CP in the remote UI proxy server 700 to transmit a command for controlling the AV device to the AV device.

The third control command transmitter can acquire a URI corresponding to the CP in the remote UI proxy server 700 through a UI resource provided in advance by the remote UI server 600.

The remote UI client 800 can be a user device in the home network.

The AV device performs various controls, such as reproduction of content, stop of the content reproduction, and a channel change, by receiving a control command from the remote UI client 800.

While exemplary embodiments have been particularly shown and described, it will be understood by those skilled in the art that various changes in form and details may be made therein without departing from the spirit and scope of the inventive concept as defined by the appended claims.

For example, as illustrated in FIGS. 6 to 8, each of the remote UI server 600, the remote UI proxy server 700, and the remote UI client 800 according to exemplary embodiments can include a bus coupled with individual units thereof, at least one processor coupled with the bus, and a memory coupled with the at least one processor to perform the above-described commands, which is coupled with the bus to store a command, a received message, and a generated message.

The system can also be embodied as computer readable code on a computer readable recording medium. The computer readable recording medium is any data storage device that can store data which can be thereafter read by a computer system. Examples of the tangible computer readable recording medium include magnetic storage media (such as read-only memory (ROM), floppy disks, and hard disks), optical reading media (such as CD-ROMs and DVDs), etc. The computer readable recording medium can also be distributed over network coupled computer systems so that the computer readable code is stored and executed in a distributed fashion.

What is claimed is:

1. A method of providing a remote User Interface (UI) service in a remote UI server, comprising:
receiving description information of a remote UI client and an Audio Video (AV) device from a remote UI proxy server;
generating a first UI resource based on the received description information; and
transmitting the first UI resource to the remote UI client in response to a request of the remote UI client.

2. The method of claim 1, wherein the first UI resource includes a device control UI for controlling the remote UI client and the AV device and a content UI for controlling broadcast content; and
the first UI resource is realized using at least one of a web page, a bitmap of applications, and a graphic primitive of applications, and provides a UI for receiving a control command for controlling the devices and the broadcast content.

3. The method of claim 2, further comprising:
receiving a broadcast content control command for controlling the broadcast content from the remote UI client;
controlling the broadcast content based on the broadcast content control command;
generating a second UI resource for providing a UI related to outputting a control result of the broadcast content, based on the control result of the broadcast content; and
transmitting the second UI resource to the remote UI client.

4. The method of claim 1, wherein the remote UI server is a headend device.

5. A method of providing a remote User Interface (UI) service in a remote UI proxy server, comprising:
receiving first description information of at least one of a remote UI client and an Audio Video (AV) device from said at least one of the remote UI client and the AV device;
transmitting the first description information of the at least one of the remote UI client and the AV device to a remote UI server;
receiving second description information of the remote UI server from the remote UI server; and
transmitting the second description information of the remote UI server to the remote UI client.

6. The method of claim 5, further comprising receiving broadcast content from the remote UI server.

7. The method of claim 6, wherein said receiving the broadcast content from the remote UI server is based on a request of the remote UI client.

8. The method of claim 6, further comprising:
transforming the broadcast content to an Internet Protocol (IP) packet; and
transmitting the transformed broadcast content to the AV device.

9. The method of claim 8, wherein the transformed broadcast content is transmitted to the AV device based on a request of the remote UI client.

10. The method of claim 5, wherein the remote UI proxy server is one of a relay gateway (proxy gateway), a set-top box, and a Personal Video Recorder (PVR).

11. A method of providing a remote User Interface (UI) service in a remote UI client, comprising:
receiving description information of a remote UI server from a remote UI proxy server;
requesting a first UI resource from the remote UI server based on the description information; and
receiving the first UI resource from the remote UI server.

12. The method of claim 11, wherein the first UI resource includes a device control UI for controlling at least one of the remote UI client and an Audio Video (AV) device, and a content UI for controlling broadcast content; and
wherein the first UI resource is realized using at least one of a web page, a bitmap of applications, and a graphic primitive of applications, and provides a UI for receiving a control command for controlling devices and the broadcast content.

13. The method of claim 12, further comprising
transmitting a command for controlling the broadcast content to the remote UI server; and
receiving a second UI resource for providing a UI related to outputting a control result of the broadcast content from to the remote UI server.

14. The method of claim 12, further comprising transmitting a command for controlling the AV device by using the device control UI, to the AV device.

15. The method of claim 14, wherein the transmitting of the command for controlling the AV device by using the device control UI to the AV device comprises transmitting the command for controlling the AV device to the AV device by using one of a HyperText Transfer Protocol (HTTP) Request according to the Digital Living Network Alliance (DLNA)/Consumer Electronics Association (CEA) 2014 standard, an additional HTTP Request according to Asynchronous JavaScript and XML (Ajax), and a plug-in application performing a control point function.

16. The method of claim 12, further comprising transmitting to the remote UI proxy server a HyperText Transfer Protocol (HTTP) Request for controlling a control point in the remote UI proxy server to transmit a command for controlling the AV device, to the AV device.

17. The method of claim 11, wherein the remote UI client is a user device in a home network.

18. A remote User Interface (UI) server comprising:
an information receiver which receives description information of at least one of a remote UI client and an Audio Video (AV) device from a remote UI proxy server;
a first UI generator which generates a first UI resource based on the received description information; and
a first UI transmitter for transmitting the first UI resource to the remote UI client in response to a request of the remote UI client.

19. The remote UI server of claim 18, wherein the first UI resource includes a device control UI for controlling the at least one of the remote UI client and the AV device and a content UI for controlling broadcast content; and
wherein the first UI resource is realized using at least one of a web page, a bitmap of applications, and a graphic primitive of applications, and provides a UI for receiving a control command for controlling devices and the broadcast content.

20. The remote UI server of claim 19, further comprising:
a control command receiver which receives a command for controlling the broadcast content, from the remote UI client;
a controller which controls the broadcast content based on the broadcast content control command;
a second UI generator which generates a second UI resource for providing a UI related to outputting a control result of the broadcast content, based on the control result of the broadcast content; and
a second UI transmitter which transmits the second UI resource to the remote UI client.

21. The remote UI server of claim 18, wherein the remote UI server is a headend device.

22. A remote User Interface (UI) proxy server comprising:
a first information receiver which receives first description information of at least one of a remote UI client and an Audio Video (AV) device from the at least one of the remote UI client and the AV device;
a first information transmitter which transmits the first description information of the at least one of the remote UI client and the AV device, to a remote UI server;
a second information receiver which receives second description information of the remote UI server from the remote UI server; and
a second information transmitter which transmits the second description information of the remote UI server to the remote UI client.

23. The remote UI proxy server of claim 22, further comprising a content receiver which receives broadcast content from the remote UI server.

24. The remote UI proxy server of claim 23, wherein the content receiver receives the broadcast content from the remote UI server based on a request of the remote UI client.

25. The remote UI proxy server of claim 23, further comprising:
a content transformer which transforms the broadcast content to an Internet Protocol (IP) packet; and
a content transmitter which transmits the transformed broadcast content to the AV device.

26. The remote UI proxy server of claim 25, wherein the content transmitter transmits the transformed broadcast content to the AV device based on a request of the remote UI client.

27. The remote UI proxy server of claim 22, wherein the remote UI proxy server is one of a relay gateway (proxy gateway), a set-top box, and a Personal Video Recorder (PVR).

28. A remote User Interface (UI) client comprising:
an information receiver which receives description information of a remote UI server from a remote UI proxy server;
a UI requester which requests a first UI resource from the remote UI server based on the description information; and
a first UI receiver which receives the first UI resource from the remote UI server.

29. The remote UI client of claim 28, wherein the first UI resource includes a device control UI for controlling at least one of the remote UI client and an Audio Video (AV) device, and a content UI for controlling broadcast content; and
wherein the first UI resource is realized using at least one of a web page, a bitmap of applications, and a graphic primitive of applications, and provides a UI for receiving a control command for controlling devices and the broadcast content.

30. The remote UI client of claim 28, further comprising
a first control command transmitter which transmits a command for controlling the broadcast content to the remote UI server; and
a second UI receiver which receives a second UI resource for providing a UI related to outputting a control result of the broadcast content from the remote UI server.

31. The remote UI client of claim 29, further comprising a second control command transmitter which transmits a command for controlling the AV device by using the device control UI, to the AV device.

32. The remote UI client of claim 31, wherein the second control command transmitter transmits the command for controlling the AV device to the AV device by using one of a HyperText Transfer Protocol (HTTP) Request according to the Digital Living Network Alliance (DLNA)/Consumer Electronics Association (CEA) 2014 standard, an HTTP Request according to Asynchronous JavaScript and XML (Ajax), and a plug-in application performing a control point function.

33. The remote UI client of claim 29, further comprising a third control command transmitter which transmits to the remote UI proxy server a HyperText Transfer Protocol (HTTP) Request for controlling a control point in the remote UI proxy server to transmit a command for controlling the AV device, to the AV device.

34. The remote UI client of claim 28, wherein the remote UI client is a user device in a home network.

35. A computer readable recording medium configured to perform a set of operations based on a corresponding set of instructions contained in the computer-readable medium, the set of operations comprising the operations set forth in the method of claim 1.

36. A computer readable recording medium configured to perform a set of operations based on a corresponding set of instructions contained in the computer-readable medium, the set of operations comprising the operations set forth in the method of claim 5.

37. A computer readable recording medium configured to perform a set of operations based on a corresponding set of instructions contained in the computer-readable medium, the set of operations comprising the operations set forth in the method of claim 9.
